(19) United States
(12) Patent Application Publication
(10) Pub. No.: US 2007/0089144 A1
(43) Pub. Date: Apr. 19, 2007

(54) Wireless HDTV display link

(76) Inventors: Thomas L. Du Breuil, Ivyland, PA (US); Kun-Pei P. Chen, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/249,281

(22) Filed: Oct. 13, 2005

(51) Int. Cl. H04N 7/18

(52) U.S. Cl. 725/81

(57) ABSTRACT

A method and apparatus for transmitting a video signal from a set-top box to a display. Steps of the method include: receiving a raw signal, processing the raw signal into a ready-for-HDTV signal, compositing the ready-for-HDTV signal with at least one graphic element, encoding the composited signal using a video codec employing a protocol such as an MPEG-2 SP@HL protocol, transmitting the encoded signal to a television receiver, receiving the transmitted signal at the television receiver, decoding the received signal, and displaying the decoded signal. The apparatus includes: either an existing or a custom set-top box, the set-top box including external or internal circuitry, respectively, for processing raw video from a video source and circuitry for compositing graphic elements with a video signal, and external or internal circuitry for encoding a processed video signal using a video codec such as an MPEG-2 SP@HL protocol, and circuitry for transmitting the video signal to a television. The apparatus may further include circuitry to decode the transmitted signal at the HDTV, as well as circuitry to accommodate audio signals.

### FIELD OF THE INVENTION

The invention relates to communications between high definition (“HD”) television set-top receivers and HD display devices.

### BACKGROUND OF THE INVENTION

In HD television systems, HD “set-top receivers” receive information from a signal source, such as a cable or satellite service, and pass the visual information through to an HD display device, such as a flat panel HDTV mounted on a user's wall.

The connection between the set-top receiver and the HD display device is usually a cable that runs from one to the other. However, such a cable is often unsightly, especially when the HD display device is mounted on a wall. As such, the cable detracts from the otherwise aesthetic positioning of the HD display device on the wall, counteracting the reason for mounting the HD display device there in the first place, or requiring costly professional installation with the wiring fished through the walls.

Some solutions have been attempted to alleviate this problem. For example, a wireless link has been attempted to connect the set-top receiver and the HD display device. However, such attempts have only achieved low-bandwidth transmissions, e.g., less than 20 Mps.

However, such solutions are not full-system solutions. In particular, they fail to handle the graphics and user interface that are often desired. Instead, they provide only an HD display, and in some cases, very limited graphics for certain simple user interactions. As an example of the graphics limitations, the graphics may be slow or of low resolution, or both.

As a particular example, EIA 775 provides a mechanism to transmit simple graphics over a limited bandwidth link, but the performance capabilities are limited in resolution and refresh rate. Moreover, there is no requirement that standard displays provide support for EIA 775, and those that do are not required to meet any particular performance requirement.

### BRIEF DESCRIPTION OF THE DRAWINGS

FIG. 1 shows a schematic diagram of a system, in which a set-top box encodes the HDTV signal prior to communication with an HDTV display via a wireless link.

FIG. 2 shows a schematic process showing what processing may occur by certain of the elements of FIG. 1.

FIG. 3 shows a schematic process showing further processing that may occur by certain of the elements of FIG. 1.

FIG. 4 shows various video sources that may be employed by the system.

FIG. 5 shows a schematic diagram of another system, in which a set-top box encodes the HDTV signal prior to communication with an HDTV display via an AC power line.

### DETAILED DESCRIPTION

In this specification, the term “raw signal” refers to the modulated signal that is received either from an antenna or cable feed. Processing that may later occur on a raw signal includes demodulation, decryption, decoding, composition with local graphics, and mixing and scaling to the appropriate output format and resolution. In other words, “raw” may refer to the state of the signal in the air or on a coaxial cable prior to the set top box processing, i.e., the compressed video signal wrapped in an envelope appropriate for the delivery method to the box, e.g., 8-VSB for ATSC over-the-air reception, QAM for cable reception, QPSK for satellite reception, and IP packets for IP delivery. However, in systems pertaining to transmitting PC signals to an HDTV, “raw” is used to refer to the VGA or DVI signal that typically goes from the PC output to the computer monitor input.

The term “ready-for-HDTV” is intended to mean that the signal may be readily processed by a standard HDTV, or may at least be readily processed by a standard HDTV to which a dongle or other such similar circuitry is connected. On the other hand, an HD-ready device refers to a device that can render an HD resolution display (e.g., greater than or equal to 720×1280 pixels, 30 frames/second) when driven with an HD signal via a supported interface such as component video, DVI, or HDMI. “HD Built-In” typically means “HD Ready” but also includes an HD-capable tuner. Many “HD Built-In” HDTVs include both ATSC off-air and Digital Cable Ready (DCR) tuners for use with, e.g., CableCard.

The term “encoding” is used to refer to any process by which a video signal is compressed such that the overall bandwidth requirements required to transmit the signal are reduced enough to where wireless (or wired as described below) technologies may be employed to transmit the same to an HDTV, HD Ready TV, or HD Built-In TV. MPEG-2 Encoding devices and circuits are available from Motorola, Inc. of Schaumberg, Ill.

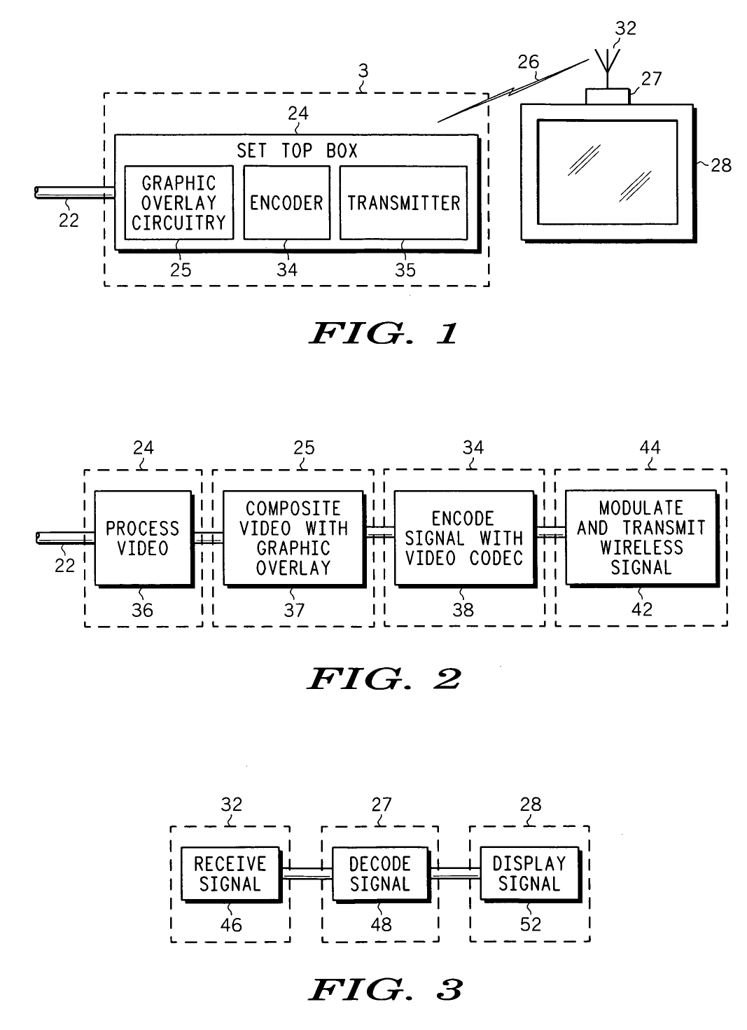

Referring to FIG. 1, a system is shown in which a raw signal source, such as cable 22, provides a signal to a set-top box 24. The raw signal from cable 22 is processed by set-top box 24 in known fashion to create a ready-for-HDTV or ready-for-TV video signal.

Two additional circuit elements within set-top box 24 may perform additional processing on the video signal.

First, a graphic element may be composited via optional graphic overlay circuitry 25 with this ready-for-HDTV video signal. The graphic element may be, e.g., a menu, title, or other on-screen element. It is generally known how to composite graphic elements with video signals. Circuitry 25 may be circuitry in the set-top box 24 that is separate from, or integrated with, the video processing circuitry. In fact, element 25 may be provided as part of a separate circuit, such as part of a dongle, that may be retrofitted to a prior art set-top box.

The graphic elements employed may be arbitrary and may incorporate substantial degrees of complexity. One reason such complexity is permitted is that the composite video signal will be encoded prior to the same's wireless transmission to the HDTV. Typical graphic elements include a graphic indication of “PAUSE”, as well as elements that are usually only temporary, such as graphic indications of “PLAY “STOP”, “FAST-FORWARD”, etc. Other graphic elements may include menu driven options, such as for parental controls, EPG menus/displays, VOD menus/displays, other “interactive TV” applications, etc. Other options include any type of graphics that would appear on a TV display during any TV viewing or interacting experience that is generated by or for the consumer. This includes elements caused by the consumer pushing buttons on their set-top remote control.

Next, as noted, the composite video signal is encoded by a video codec such as encoder 34, which may form part of the set-top box 24. The video codec allows a wireless link by encoding the composite of the graphics and video signal, or just the video signal in the case where no graphics are employed, thus preserving all the information for the display at the far end of the link. Encoding of the audio portion may occur at the same or at a different time. The audio portion may be uncompressed due to the lower bandwidth requirements or may be processed by an audio codec. Encoder 34 may be provided as part of a separate circuit, such as part of a dongle or separate box, that may be retrofitted to a prior art set-top box. The signal is transmitted via a transmitter 35 to the HDTV.

The encoding allows the composite video signal to be compressed enough to be sent wirelessly to an HDTV 28 without substantial loss of quality. The wireless signal is received by an antenna 32 or other signal-receiving device coupled to or within HDTV 28. A standard MPEG-2 MP@HL decoder 27 included in a receiver may then decode the transmitted video signal properly. Many HDTVs include such a decoder as it is required as part of the current US DTV tuner mandate. The MPEG-2 MP@HL decoder may also be provided as a separate element attached to HDTV 28, such as in a dongle or other type of connected element. In any case, following the decoding step the decoded signal may be displayed by the HDTV.

Steps of the method are shown in more detail in FIG. 2. The raw signal is processed (step 36) so as to create a ready-for-HDTV signal. A step of compositing this ready-for-HDTV signal with a graphic overlay (step 37) may then be performed. It is understood that the scope of the system is not limited to cases where graphic overlays are continuously presented. Typically, graphic overlays appear for a short time and disappear.

The signal is encoded (step 38) with an encoder so as to create a signal that is of high quality and yet which may be transmitted to an HDTV using a wireless technique. The encoded signal is then transmitted to the HDTV (step 42) for decoding and display.

Further steps of the method are shown in FIG. 3. The encoded and transmitted signal is received at the HDTV (step 46) and subsequently decoded (step 48). This decoding may occur either via circuitry present within the HDTV or via a separate box or dongle attached to the HDTV. The decoded signal may then be displayed (step 52).

Various types of raw signals are shown in FIG. 4. Raw signals may be from sources such as a PC or media center 54, a satellite dish 56, and as noted previously via cable 22. In particular, for the PC 54, many current HDTV displays can accommodate inputs from a PC such as SVGA. The bandwidth in an SVGA link, like that of a decompressed HD signal, is also greater than I Gbps and generally cannot be transmitted wirelessly by any currently practical consumer technology. However, a system may employ the same encoding scheme, such as MPEG-2 SP@HL, to transmit such SVGA signals.

The codec or encoder used may vary. In one example, an MPEG-2 encoder is used which is fashioned without B-frames and which is run at a high bit rate. MPEG-2 refers to a family of video compression algorithms with data rates from below 4 and up to 100 Mbps. For example, the system may employ an MPEG-2 SP@HL (Simple Profile at High Level) encoder in the set-top box, or in a dongle retrofitted to a set-top box, after the video signal from the cable or other signal source and/or graphics signals have been fully processed and composited. Encoding at Simple Profile (“SP”), i.e., without B-frames, is effective and inexpensive. Encoding in this manner may sacrifice a certain amount of quality, but systems may compensate for this by encoding at higher bit rates, e.g., at 40-50 Mbps. Moreover, the lack of B-frames results in shorter latency which is beneficial to user interactions with the display. Of course, an MPEG-2 MP@HL or other more advanced codecs such as MPEG-4 Part 2, MPEG-4 Part 10, SMPTE VC-1, etc., may also be employed, and are considered as alternative systems, but the same are generally more expensive. Alternative implementations could include MPEG-2 PP@HL (4:2:2) for business boardroom applications, such as wireless links to a presentation projector, and in the future, there could be many other preferred implementations based on silicon evolution. Custom-designed codecs could also be employed.

Systems may employ several different wireless transmission schemes, having rates of, e.g., 50-200 Mbps. These include UWB, 802.11n, and 802.11n proprietary variants, pre-802.11n proprietary variants, as well as Ethernet, MoCA, and the like.

Alternative systems may also use certain wired transmission schemes. For example, systems may employ protocols that use home or office AC power lines, including HomePlugAV and other powerline networking variants, HPNA3 and other phone line networking variants, etc. Such a system is “wired”, but appears wireless to the user as it is necessary to power the HDTV anyway. The bandwidth requirements of such a system are similar to the wireless systems described above. It is estimated that most households currently could achieve 50 Mbps. Thus, similar codecs would be required to transmit signals to the pertinent HDTV.

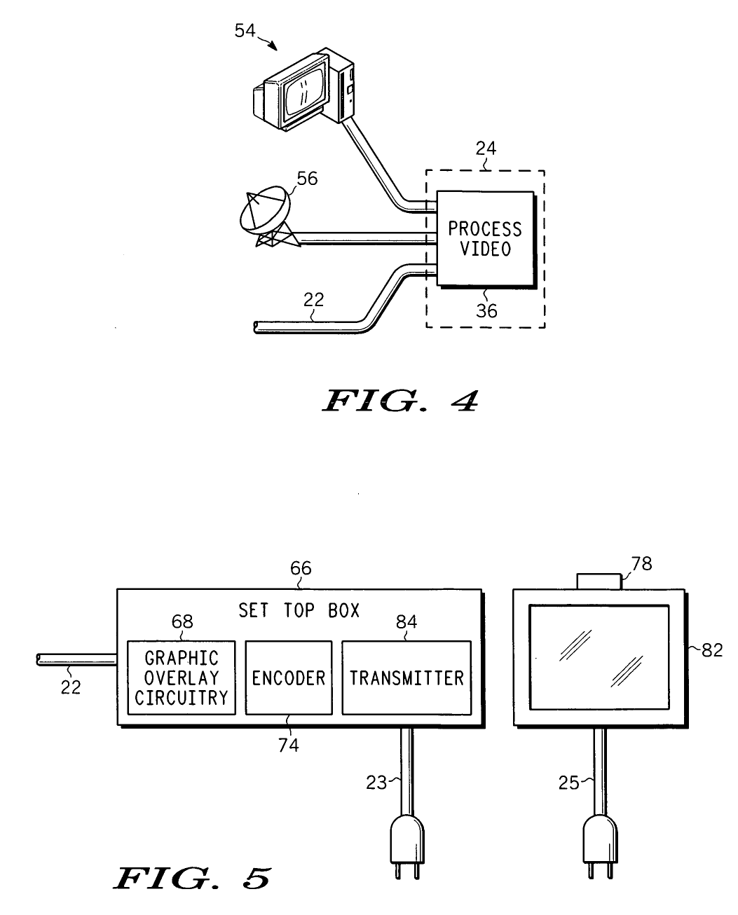

In more detail, and referring to FIG. 5, a system is shown in which the raw signal source cable 22 provides a signal to a set-top box 66. The raw signal from cable 22 is processed by set-top box 66 in known fashion to create a ready-for-HDTV video signal. A graphic element may be composited via graphic overlay circuitry 68 with this ready-for-HDTV video signal. The composite video signal is then encoded by a video codec such as encoder 74. As noted above, encoder 74 may be provided as part of a separate circuit, such as part of a dongle or separate box, that may be retrofitted to a prior art set-top box. The signal is transmitted via a transmitter 84 to the home or premise AC power lines via power line 23. The signal is received by the HDTV via its AC power line 25 and decoded as above.

It should be noted that the description above refers to specific systems, but that the scope of the invention is to be limited only by the scope of the claims appended hereto. For example, while the term “codec” has been used ubiquitously here due to its prevalence in the art, only an encoding function need be provided by encoder 34. No decoding function is necessary. However, either a codec or just an encoder may be employed, and the term codec is intended to apply to either.

Moreover, while the system has been described with respect to video applications, the same or similar systems may be further employed for audio applications, and particularly for audio/video applications. Audio, which is typically much less bandwidth-intensive than video, may be transmitted either uncompressed or compressed via a modern codec such as Dolby Digital, AAC, MP3, or WMA.

While this description has generally used the term “dongle” to refer to adaptor-type devices, it is noted that the term “dongle” is intended to refer to an adapter device for a specific purpose. In this case, an aftermarket dongle kit may include one or two different dongles. One dongle would accept HD video input via component video, DVI, HDMI, etc., and would encode this with MPEG-2 at a high bit rate and transmit this wirelessly using 802.11n, for example. A companion dongle, located at the TV, may receive this 802.11n transmission, decode the MPEG-2 signal, and output this video/audio signal via component video, DVI, HDMI, etc. for connection to the TV.

1. An apparatus for allowing a TV signal to be transmitted wirelessly from a set-top box to an HDTV, comprising:
a. a processor within a set-top box to convert a raw signal to a ready-for-HDTV signal;
b. a circuit to composite a graphic element onto the converted signal;
c. an encoder to convert the composited signal; and
d. a transmitter within the set-top box to transmit the encoded signal.

2. The apparatus of claim 1, wherein the encoder encodes in a protocol selected from the group consisting of: MPEG-2 SP@HL, MPEG-4 Part 10, MPEG-2 PP@HL, and SMPTE VC-1.

3. The apparatus of claim 1, further comprising circuitry for encoding a processed audio signal using an audio codec.

4. The apparatus of claim 1, wherein the encoder is enclosed in a dongle.

5. The apparatus of claim 1, wherein the encoder is within the set-top box.

6. The apparatus of claim 1, wherein the TV signal is an HDTV signal.

7. The apparatus of claim 1, wherein the TV signal is a PC signal.

8. The apparatus of claim 1, wherein the transmitter transmits wirelessly.

9. The apparatus of claim 1, wherein the transmitter transmits via an AC power line.

10. An HDTV for displaying a wirelessly-transmitted signal, comprising:
a. an antenna circuit to receive an encoded wireless signal;
b. a decoder to convert the encoded wireless signal into a ready-for-HDTV signal;
c. a display circuit to display the decoded signals on the HDTV screen.

11. The HDTV apparatus of claim 10, wherein the decoder is selected from the group consisting of: MPEG-2 MP@HL, MPEG-4 Part 2, MPEG-4 Part 10, SMPTE VC-1, and MPEG-2 PP@HL.

12. The HDTV apparatus of claim 10, wherein the decoder is disposed within the HDTV.

13. The HDTV apparatus of claim 10, wherein the decoder is disposed within a dongle attached to the HDTV.

14. The HDTV apparatus of claim 10, wherein the encoded wireless signal includes a graphic element.

15. A method for transmitting a signal from a set-top box to an HDTV television, comprising:
receiving a raw signal;
processing the raw signal into a ready-for-HDTV signal;
compositing the ready-for-HDTV signal with at least one graphic element;
encoding the composited signal; and
transmitting the composited signal to an HDTV.

16. The method of claim 15, wherein the encoding uses a protocol selected from the group consisting of: MPEG-2 SP@HL, MPEG-4 Part 10, MPEG-2 PP@HL, and SMPTE VC-1 protocols.

17. The method of claim 15, wherein the encoding is performed by a dongle attached to a set-top box.

18. The method of claim 15, wherein the encoding is performed by a encoder disposed in a set-top box.

19. The method of claim 15, wherein the transmitting includes transmitting wirelessly.

20. The method of claim 15, wherein the transmitting includes transmitting via an AC power line.
